(19) United States
(12) Patent Application Publication
(10) Pub. No.: US 2012/0264837 A1
(43) Pub. Date: Oct. 18, 2012

(54) Flameproof expandable polymerizates

(75) Inventors: Roman Eberstaller, Ober-Grafendorf (AT); Gerhard Hintermeier, St. Poelten (AT)

(73) Assignee: SUNPOR KUNSTSTOFF GES.m.b.H, St. Poelten (AT)

(21) Appl. No.: 13/497,521

(22) PCT Filed: Sep. 22, 2010
(86) PCT No.: PCT/AT10/00346

§ 371 Date: Jul. 3, 2012

(30) Foreign Application Priority Data
Sep. 24, 2009 (AT) A 1505/2009
Sep. 24, 2009 (AT) A 1506/2009

(51) Int. Cl. C08L 25/06; C08J 9/00; C08K 5/43; C08K 5/53; C08K 3/30

(52) U.S. Cl. 521/85

(57) ABSTRACT

The invention relates to flameproof expandable polymerizates, wherein a flame retardant system consisting of a combination of at least one phosphorus compound as a flame retardant and at least one sulfur compound as an additional flame retardant or synergist is contained.

According to the invention, it is contemplated that the phosphorus compound is
elemental phosphorus and/or
at least one inorganic phosphorus compound and/or
at least one organic phosphorus compound of the following general formula (I) or (II):

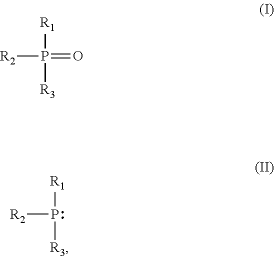

wherein the residues R₁, R₂, and R₃ each independently represent organic or inorganic residues,
   and that said sulfur compound is
elemental sulfur and/or
at least one inorganic or organic sulfur compound and/or sulfur-containing compound.

In a first aspect, the present invention relates to flameproof expandable polymerizates containing at least one blowing agent, in which a combination of at least one phosphorus compound serving as a flame retardant and at least one sulfur compound serving as an additional flame retardant or synergist is contained as a flame retardant system.

The invention further relates to methods of manufacturing these polymerizates, and further to polymeric foams protected by these flame retardant systems and to methods of manufacturing the same as well as to the specific use of the above flame retardant systems in expandable polymerizates and polymeric foams.

In a second, particularly advantageous aspect, the invention relates to flameproof expandable polymerizates containing at least one blowing agent, in which, as a flame retardant system, at least one phosphorus compound of the following general formula (I) or hydrolyzates or salts thereof is/are contained:

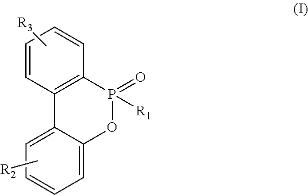

wherein each R represents independently:

—H, substituted or unsubstituted C₁₋₁₅ alkyl, C₁₋₁₅ alkenyl, C₃₋₈ cycloalkyl, C₆₋₁₈ aryl, C₇₋₃₀ alkylaryl, C₁₋₈ alkoxy or C₁₋₈-alkylthio or —OH or —SH as well as alkali metal, alkaline earth metal, ammonium or phosphonium salts thereof.

The invention according to the second aspect further relates to methods of manufacturing these polymerizates, and further to polymeric foams protected by these flame retardant systems, and to methods of manufacturing the same as well as to the specific use of the above flame retardant systems in expandable polymerizates and polymeric foams.

### First Aspect of the Invention (Claims 1 to 16)

The modification of polymeric foams with flame retardants is important and/or compulsory in many fields. Regulations on the use of polystyrene particle foams of expandable polystyrene (EPS) or the use of plates of extruded polystyrene foam (XPS) as an insulating material for buildings in most cases require a flame protective modification. Polystyrene homo- and copolymers are predominantly rendered flame resistant by halogen-containing, in particular brominated, organic compounds such as hexabromocyclododecane (HBCD). However, this and a number of other brominated substances are under consideration or have already been prohibited because of potential environmental and health hazards.

Known alternatives are various halogen-free flame retardants. However, in order to achieve the same flame retardant effects as with halogen-containing flame retardants, halogen-free flame retardants usually have to be applied in substantially higher amounts.

This is one reason why, frequently, halogen-free flame retardants that may be used in compact thermoplastic polymers cannot be used in a similar way in polymeric foams, since they either interfere with the foaming process or affect the mechanical and thermal properties of the polymeric foam. In the preparation of expandable polystyrene via suspension polymerization, high amounts of flame retardants may also reduce the stability of the suspension and thus interfere with or affect the manufacturing method.

The effect of flame retardants used for compact polymers on polymeric foams is often unpredictable because of peculiarities of such foams and their different fire behavior or because of differing fire tests.

The use of phosphorus-containing substances in expandable polymerizates is generally known in the art.

EP-A 834 529 describes expandable styrene polymers containing a mixture of a phosphorus compound and a water-eliminating metal hydroxide as a halogen-free flame retardant. Preferably, 5 to 10% by weight of Mg(OH) and 5 to 10% by weight of triphenyl phosphate (TPP) are incorporated into melted polystyrene in an extruder and granulated, and the granulate is re-impregnated in an aqueous suspension with a blowing agent.

WO 00/34342 describes a method of preparing expandable polystyrene by suspension polymerization of styrene in the presence of 5 to 50% by weight of expandable graphite and optionally 2 to 20% by weight of a phosphorus compound as a flame retardant.

Moreover, for example, in WO 2006/027241 a halogen-free flame retardant for polymeric foams is described, i.e. the phosphorus compound 9,10-dihydro-9-oxa-10-phosphaphenanthrene-10-oxide (6H-dibenzo[c,e]-oxaphosphorino-6-oxide, DOPO, CAS [35948-25-5]).

This flame retardant is already relatively well employable, however, there is a need of rendering such polymerizates and polymeric foams even more fire resistant while keeping the content of flame retardants as low as possible or without increasing the content of flame retardants.

It is thus the object of the first aspect of the present invention to create a sufficiently fire resistant, flameproof, expandable polymerizate having a low flame retardant content and good quality.

To this end, it is particularly desirable that the polymer is able to meet even the strictest requirements in terms of fire resistance, e.g. for use in construction, such as, for example, the B2 small-flame test according to DIN 4102-2 or the flammability test according to EN 11925-2.

A further object of the first aspect of the invention is to create an advantageous method for manufacturing such polymerizates.

A further object of the first aspect of the invention is to create a polymeric foam being protected against flames without the use of halogens, but still having sufficient quality and advantageous fire behavior as well as good mechanical properties, as well as an advantageous method of preparing the same.

These objects are achieved by the independent claims 1, 9, 12, and 16 according to the first aspect of the invention.

In the case of a polymerizate or polymeric foam of the above-mentioned type, the object is achieved by the phosphorus compound acting as a flame retardant in the flame retardant system being:
elemental phosphorus, in particular red phosphorus, and/or
at least one inorganic phosphorus compound, or hydrolyzates or salts thereof, and/or
at least one organic phosphorus compound of the following general formula (I) or (II), or hydrolyzates or salts thereof:

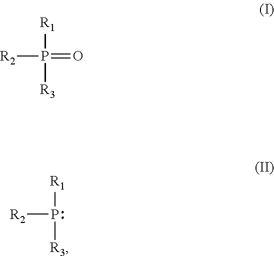

wherein the residues R₁, R₂ and R₃ each independently represent organic or inorganic residues,

and by the sulfur compound acting as a flame retardant and/or synergist being:
elemental sulfur and/or
at least one inorganic or organic sulfur compound and/or sulfur-containing compound.

Surprisingly, it was found that such flameproof polymerizates and polymeric foams have a flame-retarding effect that is improved to an unexpectedly high extent. Thus, the total amount of flame retardants can be reduced, which brings about a plurality of advantages, for example, regarding the manufacturing method, costs, mechanical features of the product, etc. In particular the foaming process and the mechanical features of the foam will not be substantially effected, which results in a product of high quality.

The term “phosphorus compounds” as used in the present text means and/or summarizes both elemental phosphorus and organic and inorganic phosphorus compounds and/or phosphor-containing compounds, as well as hydrolyzates or salts thereof.

Elemental phosphorus exists in four allotropic modifications as white, red, black, and violet phosphorus. Each of these basic types forms different crystal structures, which results in differing physical properties and reactivities. As a flame retardant, red phosphorus is used most advantageously.

As inorganic phosphorus compounds, it is advantageous to use (poly)phosphates such as non-condensed salts of phosphorous acid or condensed salts such as ammonium phosphate and ammonium polyphosphate.

The organic phosphorus compounds of the general formula (I) or (II), as used according to the invention:

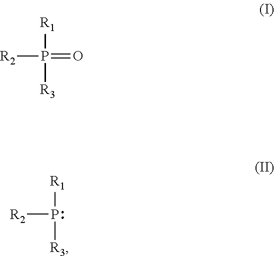

can be selected from organic phosphorus compounds such as monomeric organic phosphorus compounds or polymeric organic phosphorus compounds, inorganic phosphorus compounds, etc., where R₁, R₂, and R₃ independently represent organic or inorganic residues, which are known to those skilled in the art.

The substituents or residues R are mutually independent and can be the same or different or even absent altogether. Preferably, the residues R may each independently represent —H, substituted or unsubstituted C₁₋₁₅ alkyl, C₁₋₁₅ alkenyl, C₃₋₈ cyclo-alkyl, C₆₋₁₈ aryl, C₇₋₃₀ alkylaryl, C₁₋₈ alkoxy or C₁₋₈ alkylthio or —OH or —SH as well as alkali metal, alkaline earth metal, ammonium or phosphonium salts thereof.

The “alkyl” part of optional substituents R of the phosphorus compounds according to formula (I) designates both saturated and unsaturated aliphates, which may be linear or branched, with unsaturated groups being preferred. Preferably, the substituents R comprise short-chained alkyl groups of not more than 6, more preferably not more than 4 or 3, even more preferably not more than 2, carbon atoms or phenyl as an aryl group. Shorter-chain residues are preferred because longer-chain residues, a higher level of saturation and a greater number of substituents can be detrimental to the flame-retarding effect. Preferably, particularly efficacious phosphorus compounds preferably unsubstituted.

If substituents R are present, they preferably have a sulfur-containing substituent such as —SH, —SO₃NH₄, —SO— or —SO₂—, for example, or a phosphorus-containing substituent such as —PO(ONH₄)₂ or the like, in order to further improve the flame-retarding effect.

Among the optional salts of any SH or OH groups of the phosphorus compounds, ammonium and phosphonium salts are preferred because they are also able to contribute to the flame-retarding effect. The ammonium and phosphonium ions may have up to four organic residues instead of hydrogen atoms, e.g. the above-defined substituents R (i.e. NR₄⁺ and PR₄⁺, respectively), with hydrogen being preferred as a substituent in the case of ammonium.

Examples of such phosphorus compounds of general formula (I) or (II) include organic phosphorus compounds and salts thereof such as monomeric organic phosphorus compounds, including phosphoric esters, phosphoric amide esters and phosphonitrile compounds, organic compounds of phosphorous acid such as esters of phosphorous acid, compounds of hypophosphorous acid, phosphines and phosphine oxides, e.g. triphenyl phosphine, triphenylphosphine oxide and tricresyl phosphine oxide, etc..

With the exception of halogenated phosphorus compounds, phosphorus compounds have the disadvantage that, as initially mentioned, normally relatively high concentrations thereof need to be used in order to achieve sufficient a flame-retarding effect. In polymeric foams, in most cases, these high concentrations result in a collapse of the foam structure. Thus, it was an object of the present invention to reduce these concentrations as much as possible. This could be achieved by adding additional sulfur-containing compounds, which surprisingly exhibited an above-average improvement of the flame-inhibiting effect.

An advantageous embodiment of such expandable polymerizates is to have the phosphorus compound(s) contained as (a) flame retardant(s) in an amount of 0.5 to 25% by weight, in particular 3 to 15% by weight, based on the total weight of the polymer.

Phosphorus compounds exhibiting a weight loss of less than 10% by weight, as analyzed by thermogravimetry (TGA) below 115° C., have been found to be advantageous.

The term “sulfur compounds” as used in the present text means and/or summarizes both elemental sulfur and organic and inorganic sulfur compounds and/or sulfur-containing compounds, as well as hydrolyzates or salts thereof.

An advantageous embodiment of such expandable polymerizates is to have the sulfur compound(s) contained as (a) flame retardant(s) in an amount of 0.5 to 25% by weight, in particular 3 to 15% by weight, based on the total weight of the polymer.

Particularly suitable are elemental sulfur and yellow cyclooctasulfur (S₈), preferably added in an amount of 0.1 to 10% by weight, preferably 0.5 to 5% by weight, most preferably about 2% by weight, based on the obtained EPS granulate.

As sulfur compounds, for example, sulfides, sulfites, sulfates, sulfanes, sulfoxylates, sulfones, thiosulfates, thionites, thionates, disulfates, sulfoxides, sulfuric nitride, sulfuric halides and/or organosulfur compounds such as thiols, thioethers, thiophenes, etc., can be advantageously used.

In addition, those sulfur compounds have been found to be advantageous which exhibit a weight loss of less than 10% by weight, as analyzed by thermogravimetry (TGA) below 115° C., such as ammonium thiosulfate, dicaprolactam disulfide, zinc sulfide, poly(phenylene sulfide), etc..

It is particularly advantageous when the sulfur-containing compound or the sulfur compound has at least one S—S bond where at least one of the sulfur atoms is present in the bivalent form, e.g. disulfites, dithionites, cystines, amylphenol disulfides, poly-tert-butylphenol disulfides, etc..

Particularly preferred combinations of phosphorus compounds and sulfur compounds are combinations of:
ammonium polyphosphate and yellow sulfur (S₈),
ammonium polyphosphate and ammonium thiosulfate,
ammonium polyphosphate and zinc sulfide,
triphenylphosphine and cystine, and
triphenylphosphine and poly(phenylene sulfide).

The inventive expandable polymerizates are preferably expandable styrene polymerizates (EPS) or expandable granular styrene polymer (EPS). Advantageously, they consist of homo- and copolymers of styrene, preferably crystal-clear polystyrene (GPPS), high-impact polystyrene (HIPS), anionically polymerized polystyrene or impact-resistant polystyrene (A-IPS), copolymers of styrene and alpha-methyl-styrene, acrylonitrile-butadiene-styrene polymerizates (ABS), styrene-acrylonitrile (SAN), acrylonitrile-styrene-acrylic ester (ASA), methylacrylate-butadiene-styrene (MBS), methylmethacrylate-acrylonitrile-butadiene-styrene (MABS) polymerizates or mixtures thereof or mixtures with poly(phenylene ether) (PPE) or poly(phenylene sulfide) (PPS). Especially with regard to polystyrene, demand for high-quality products is strong.

For improving mechanical properties or temperature resistance, the styrene polymers mentioned may be mixed, optionally using compatibilizers, with thermoplastic polymers such as polyamides (PA), polyolefins such as polypropylene (PP) or polyethylene (PE), polyacrylates such as poly(methyl methacrylate)(PMMA), polycarbonate (PC), polyesters such as poly(ethylene terephthalate)(PET) or poly(butylene terephthalate) (PBT), polyether sulfones (PES), polyether ketones, or polyether sulfides (PES), or mixtures thereof, usually in proportions of a maximum of 30% by weight in total, preferably in the range of 1 to 10% by weight, based on the polymer melt.

Additionally, mixtures in the above amount ranges can also be prepared with e.g. hydrophobically modified or functionalized polymers or oligomers, rubbers such as polyacrylates or polydienes, e.g. styrene-butadiene block copolymers, or biodegradable aliphatic or aliphatic/aromatic copolyesters.

Suitable compatibilizers are, for example, maleic anhydride-modified styrene copolymers, epoxide group-containing polymers or organosilanes.

The efficacy of the phosphorus compounds can be further improved by adding appropriate flame retardancy synergists such as the thermal radical formers dicumyl peroxide, di-tert-butyl peroxide or dicumyl.

Also, various additional flame retardants such as melamine, melamine cyanurates, metal oxides, metal hydroxides, phosphates, phosphinates, or synergists such as Sb₂O₃ or Zn compounds may be used.

In cases where the polymerizate or polymeric foam does not have to be entirely halogen-free, halogen-reduced foams may be produced by using the phosphorus compounds and adding minor amounts of halogen-containing, especially brominated, flame retardants such as hexabromocyclodecane (HBCD), preferably in amounts in the range of 0.05 to 1, especially 0.1 to 0.5, % by weight.

A further aspect of the invention relates to the preparation of such polymerizates. According to the invention, the flameproof expandable polymerizates mentioned above can be produced as generally known by admixing the above flame retardants and optionally sulfur and/or at least one sulfur-containing compound or sulfur compound.

An advantageous procedure comprises mixing one or more phosphorus compound(s), the sulfur compound(s), and a blowing agent with a styrene polymer melt using a dynamic or static mixer and subsequent granulation.

Alternatively, it may be provided that one or more phosphorus compound(s) and the sulfur compound(s) are admixed with a still granular polystyrene polymerizate using a dynamic or static mixer and then melted, and that the melt is subsequently mixed with the blowing agent and granulated.

Alternatively, it may be provided that one or more phosphorus compound(s) and the sulfur compound(s) are admixed with a still granular EPS using a dynamic or static mixer, and that the mixture is subsequently melted and granulated.

Alternatively, it may further be provided that the granulation is achieved by suspension polymerization of styrene in an aqueous suspension in the presence of one or more phosphorus compound(s), the sulfur compound(s), and a blowing agent.

A further inventive method for producing the inventive flameproof expandable styrene polymerizates (EPS) comprises the following steps:
jointly dosing granular PS or EPS having a molecular weight of Mw >120,000 g/mol, preferably 150,000 to 250,000 g/mol, more preferably 180,000 to 220,000 g/mol, one or more phosphorus compound(s), the sulfur compound(s), and optionally one or more further additives, into an extruder,
jointly melting all components in the extruder,
optionally adding at least one blowing agent,
mixing all components at a temperature >120° C.,
granulation by means of pressurized underwater granulation, e.g. at 1-20 bar, to a granule size <5 mm, preferably 0.2 to 2.5 mm, at a water temperature of 30 to 100° C., most preferably 50 to 80° C.,
optionally coating the surface with coating agents, e.g. silicates, metal salts of fatty acids, fatty acid esters, fatty acid amides.

The inventive halogen-free, flameproof expandable styrene polymers (EPS) and styrene polymer extruded foams (XPS) may be produced by admixing a blowing agent, one or more phosphorus compound(s) and elemental sulfur and/or a sulfur-containing compound or sulfur compound into the polymer melt and subsequent extrusion to give foam sheets, foam strands, or expandable granules.

Preferably, the expandable styrene polymer has a molecular weight >120,000, more preferably in the range of 180,000 to 220,000 g/mol. Due to a decrease in molecular weight because of shearing and/or temperature effects, the molecular weight of the expandable polystyrene is usually about 10,000 g/mol lower than the molecular weight of the polystyrene used.

Further, recycled polymers of the thermoplastic polymers mentioned, especially styrene polymers and expandable styrene polymers (EPS), may be added to the styrene polymer melt, i.e. in amounts that do not substantially deteriorate their properties, usually in amounts of maximum 50% by weight, especially in amounts of 1 to 20% by weight.

The blowing agent-containing styrene polymer melt usually contains one or more homogeneously distributed blowing agent(s) in a proportion of 2 to 10% by weight in total, preferably 3 to 7% by weight, based on the blowing agent-containing styrene polymer melt. Suitable blowing agents are physical blowing agents usually used in EPS such as aliphatic hydrocarbons of 2 to 7 carbon atoms, alcohols, ketones, ethers or halogenated hydrocarbons. Preferably, iso-butane, n-butane, iso-pentane, or n-pentane is used. For XPS, preferably CO₂ or mixtures thereof with alcohols or ketones are used.

The amount of blowing agent added is selected such that the expandable styrene polymers (EPS) have an expansivity of 7 to 200 g/L, preferably 10 to 50 g/L.

The inventive expandable granular styrene polymer (EPS) usually has a bulk density of not more than 700 g/L, preferably in the range of 590 to 660 g/L.

Furthermore, additives, nucleation agents, fillers, plasticizers, soluble and insoluble inorganic and/or organic dyes and pigments, e.g. IR absorbers such as carbon black, graphite or aluminum powder, may be added to the styrene polymer melt, jointly or in a spatially separated way, e.g. via mixers or side extruders. Usually, the dyes and pigments are added in amounts in the range of 0.01 to 30, preferably in the range of 1 to 10, % by weight. For a homogeneous and microdisperse distribution of the pigments in the styrene polymer, it may be useful, especially for polar pigments, to use a dispersing agent, e.g. organosilanes, epoxy group-containing polymers, or maleic anhydride-grafted styrene polymers. Preferred plasticizers are mineral oils, phthalates, which are used in amounts of 0.05 to 10% by weight, based on the styrene polymerizate.

A further aspect of the invention relates to a polymeric foam, espcecially a styrene polymer particle foam or an extruded polystyrene rigid foam (XPS) containing at least one of the above described phosphorus compounds as well as elemental sulfur and/or at least one sulfur-containing compound or sulfur compound as (a) flame retardant(s).

An advantageous polymeric foam is obtainable from the flameproof expandable polymerizates according to the invention, in particular from expandable styrene polymerizates (EPS), in particular by foaming and caking the polymerizate beads or by extruding the granulate.

Preferably, the halogen-free, flameproof polymeric foams have a density in the range of 8 to 200 g/L, most preferably in the range of 10 to 50 g/L, and they are preferably more than 80%, most preferably 95 to 100%, closed-cell foams and/or have a predominantly closed-cell structure with more than 0.5 cells per mm³.

According to the invention at least one of the phosphorus compounds is used in combination with sulfur and/or a sulfur-containing compound or sulfur compound as a flame retardant or synergist in expandable polymerizates, particularly in expandable styrene polymerizates (EPS) or expandable styrene polymer granulates (EPS), or in polymeric foams, in particular in styrene polymer particle foams, as obtainable by foaming from expandable polymerizates, or in extruded polystyrene rigid foams (XPS).

For producing a flameproof extruded polystyrene rigid foam (XPS), the phosphorus compounds, the sulfur compounds and a blowing agent are mixed with a styrene polymer melt using a dynamic or static mixer and then foamed, or the phosphorus compounds and the sulfur compounds are added using a dynamic or static mixer to a still granular polystyrene polymerizate and then melted, whereafter the melt is added with blowing agent and foamed.

The phosphorus compounds and the sulfur compounds that can be used and methods of preparing the same are known per se to those skilled in the art from general knowledge in the art.

Methods for preparing expandable polymerizates rendered flameproof therewith, e.g. such of EPS, in the form of granulates or beads are also known per se to those skilled in the art. Preparation of polymerizates according to the invention comprising the above phosphorus compounds and sulfur compounds is substantially analogous. For example, the exemplary embodiments of WO 2006/027241 can be used. The same is true for the polymeric foams and for XPS.

How to add the sulfur or the sulfur compounds is also known. For example, elemental sulfur can be introduced in an encapsulated form or in the form of coated granulates or particles.

The present invention according to its first aspect will now be described in detail by way of example, based on five specific exemplary embodiments 1 to 5 which are not to be construed as limiting, though. Examples 6 to 10 are comparative examples in order to show the synergistic effect of the flame retardant system.

The specific advantageous exemplary embodiments show flame retardant combinat- ions of:
ammonium polyphosphate (APP) and yellow sulfur (S₈),
ammonium polyphosphate (APP) and ammonium thiosulfate (ATS),
ammonium polyphosphate (APP) and zinc sulfide (ZnS),
triphenylphosphine and cystine, and
triphenylphosphine and polyphenylene sulfide (PPS).

### EXAMPLE 1

### Exemplary Embodiment—APP+S

To a styrene polymer (SUNPOR EPS-STD, 6% by weight pentane, chain length Mw=200,000 g/mol, polydispersity Mw/Mn=2.5) 12% by weight of ammonium polyphosphate (APP) and 2% by weight of yellow sulfur (S₈), based on the obtained EPS granulate, were admixed in the capture area of a twin-screw extruder and melted in the extruder at 190° C. The polymer melt thus obtained was conveyed through a nozzle plate at a throughput of 20 kg/h and granulated to compact EPS granulates using a pressurized underwater granulator.

### EXAMPLE 2

### Exemplary Embodiment—APP+ATS

To a styrene polymer (SUNPOR EPS-STD, 6% by weight pentane, chain length Mw=200,000 g/mol, polydispersity Mw/Mn=2.5) 12% by weight of ammonium polyphosphate (APP) and 5% by weight of ammonium thiosulfate (ATS), based on the obtained EPS granulate, were admixed in the capture area of a twin-screw extruder and melted in the extruder at 150° C. The polymer melt thus obtained was conveyed through a nozzle plate at a throughput of 20 kg/h and granulated to compact EPS granulates using a pressurized underwater granulator.

### EXAMPLE 3

### Exemplary Embodiment—APP+ZnS

To a styrene polymer (SUNPOR EPS-STD, 6% by weight pentane, chain length Mw=200,000 g/mol, polydispersity Mw/Mn=2.5) 12% by weight of ammonium polyphosphate (APP) and 5% by weight of zinc sulfide (ZnS), based on the obtained EPS granulate, were admixed in the capture area of a twin-screw extruder and melted in the extruder at 190° C. The polymer melt thus obtained was conveyed through a nozzle plate at a throughput of 20 kg/h and granulated to compact EPS granulates using a pressurized underwater granulator.

### EXAMPLE 4

### Exemplary Embodiment—Triphenylphosphine+Cystine

To a styrene polymer (SUNPOR EPS-STD, 6% by weight pentane, chain length Mw=200,000 g/mol, polydispersity Mw/Mn=2.5) 12% by weight triphenylphosphine and 5% by weight of cystine, based on the obtained EPS granulate, were admixed in the capture area of a twin-screw extruder and melted in the extruder at 190° C. The polymer melt thus obtained was conveyed through a nozzle plate at a throughput of 20 kg/h and granulated to compact EPS granulates using a pressurized underwater granulator.

### EXAMPLE 5

### Exemplary Embodiment—Triphenylphosphine+PPS

To a styrene polymer (SUNPOR EPS-STD, 6% by weight pentane, chain length Mw=200,000 g/mol, polydispersity Mw/Mn=2.5) 12% by weight of triphenylphosphine and 5% by weight of polyphenylene sulfide (PPS), based on the obtained EPS granulate, were admixed in the capture area of a twin-screw extruder and melted in the extruder at 190° C. The polymer melt thus obtained was conveyed through a nozzle plate at a throughput of 20 kg/h and granulated to compact EPS granulates using a pressurized underwater granulator.

### EXAMPLE 6

### Comparative Example to Examples 1 to 3—APP Alone

Example 1 was repeated with the difference that no sulfur or sulfur compound was added.

### EXAMPLE 7

### Comparative Example to Examples 4 and 5—Triphenylphosphine Alone

Example 4 was repeated with the difference that no sulfur or sulfur compound was added.

### EXAMPLE 8

### Comparative Example to Example 3—ZnS Alone

Example 3 was repeated with the difference that no phosphorus compound was added.

### EXAMPLE 9

### Comparative Example to Example 5—PPS Alone

Example 5 was repeated with the difference that no phosphorus compound was added.

### EXAMPLE 10

### Reference Example—HBCD

To a styrene polymer (SUNPOR EPS-STD, 6% by weight pentane, chain length Mw=200,000 g/mol, polydispersity Mw/Mn=2.5) 2% by weight of HBCD (hexabromocyclododecane), based on the obtained EPS granulate, were admixed in the capture area of a twin-screw extruder and melted in the extruder at 190° C. The polymer melt thus obtained was conveyed through a nozzle plate at a throughput of 20 kg/h and granulated to compact EPS granulates using a pressurized underwater granulator.

In the following Table 1, the results of examinations of the fire behavior of defined specimens, of the time until the foamed foam beads collapsed, and of their stability are juxtaposed in a lucid manner.

TABLE 1
Examination of expandable polymerizates and polymeric foams

| | Fire test | Stability |
|---|---|---|
| Experiment 1 (according to Example 1) | 2 | 1 |
| Experiment 2 (according to Example 2) | 2 | 1 |
| Experiment 3 (according to Example 3) | 3 | 1 |
| Experiment 4 (according to Example 4) | 1 | 3 |
| Experiment 5 (according to Example 5) | 2 | 2 |
| Experiment 6 (according to Example 6) | 5 | 1 |
| Experiment 7 (according to Example 7) | 4 | 3 |
| Experiment 8 (according to Example 8) | 5 | 1 |
| Experiment 9 (according to Example 9) | 4 | 1 |
| Reference experiment (according to Example 10) | 1 | 1 |

The experimental results in the two right-side columns were obtained by tests of products of the above described examples 1 through 10.

The examples 6 through 9 are references to examples 1 through 5. Example 10 is a reference to prior art.

All evaluations in all the examinations refer to this reference experiment 10 in that the results are designated by numbers 1 to 5, with low numbers, in particular 1, tending to be more advantageous, and high numbers, in particular 5, being more disadvantageous.

### DETAILED DESCRIPTION

### Fire Test (Column 2 in Table 1):

The EPS granulates obtained from the examples were pre-foamed with saturated steam to give foam beads having a crude density of 15 to 25 kg/m³, stored for 24 hours and molded to foam plates in a molding apparatus.

2 cm specimens were cut from the foam plates and conditioned for 72 hours before being subjected to a fire test according to DIN 4102-2 (B2—small-flame test).

The results scored with numbers from 1 to 5 were evaluated in relation to EPS flame-protected by hexabromocyclododecane (Example 8). In this connection, scores of 1 in the column headed “Fire test” indicate that the test substance acted as well as HBCD-protected EPS regarding its fire behavior. Scores of 5 indicate that the fire behavior is very poor and equals that of EPS that has not been flame-protected.

### Stability (Column 3 in Table 1) of the Foam Structures:

The EPS granulates obtained from the examples were exposed to saturated steam, and time until the beads began to collapse was determined. In the summary of the results, this time was evaluated in relation to EPS particles without flame retardant. Due to the softening effect of the flame retardants based on phosphorus, the EPS particles exhibited differing stability during pre-foaming.

In column 3, values of 1 indicate that the beads had normal stability. Values of 5 indicate that the beads collapse immediately without a foam structure being generated that would be suitable for moulding.

As clearly seen from these results, the materials of examples 1 through 5 show surprisingly clearly improved results in fire tests compared to the materials of examples 6 through 9, which were not to be expected, particularly not to this extent.

Neither adding phosphorus compounds alone (examples 6 and 7) nor adding sulfur compounds alone (examples 8 and 9) could achieve comparable results.

The fire behavior synergistically increased by simultaneous addition of the phosphorus compounds and the sulfur compounds.

The polymerizates and foams according to the invention or protected by a method of the invention are thus substantially more advantageous regarding their fire behavior compared to polymers protected by phosphorus compounds or sulfur compounds alone.

Also, surprisingly, the stability was not substantially affected or was even increased.

### Second Aspect of the Invention (Claims 17 to 33):

In a second, especially advantageous aspect, the present invention relates to flame-proof expandable polymerizates containing at least one blowing agent, in which, as a flame retardant, at least one phosphorus compound of the following general formula (I) or hydrolyzates or salts thereof is/are contained:

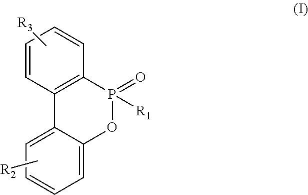

wherein each residue R represents independently:

—H, substituted or unsubstituted C₁₋₁₅ alkyl, C₁₋₁₅ alkenyl, C₃₋₈ cycloalkyl, C₆₋₁₈ aryl, C₇₋₃₀ alkylaryl, C₁₋₈ alkoxy or C₁₋₈ alkylthio or —OH or —SH, as well as alkali metal, alkaline earth metal, ammonium or phosphonium salts thereof.

According to its second aspect, the invention further relates to methods of preparing these polymerizates, further polymeric foams protected using these flame retardants and methods of preparing the same as well as the special use of above flame retardants in expandable polymerizates and polymeric foams.

Modification of polymeric foams with flame retardants is important and/or compulsory in many fields. Regulations on the use of polystyrene particle foams of expandable polystyrene (EPS) or the use of polystyrene extruded foam plates (XPS) as an insulating material for buildings require flame protection modification in most cases. Polystyrene homo- and copolymers are predominantly rendered flame-resistant by halogen-containing, in particular brominated, organic compounds such as hexabromocyclododecane (HBCD). However, this and a number of other brominated substances have been subject to discussion or banned already due to their potential environmental and health risks.

As alternatives, numerous halogen-free flame retardants exist. However, halogen-free flame retardants need to be used in markedly increased levels in order to achieve the same flame retardant effect as the halogenated flame retardants.

It is partly for this reason that halogen-free flame retardants employable in compact thermoplastic polymers often cannot be used in polymeric foams in the same way, as they either interfere with the foaming process or affect mechanical and thermal properties of the polymeric foam. In addition, in the preparation of expandable polystyrene by suspension polymerization, the high amounts of flame retardants can reduce the stability of the suspension and interfere with, or affect the manufacturing method.

In polymeric foams, the effect of flame retardants compact polymers is often unpredictable due to the special features of such foams and the varying fire behavior or differing flammability tests.

In this context, in WO 2006/027231, prior art describes a halogen-free flame retardant for polymeric foams, which does not substantially affect the foaming process while allowing the preparation of predominantly closed-cell polymeric foams. This flame retardant is a phosphorus compound that has been known and used since the early 1970s, which can be prepared, for example, according to JP-A 2004-035495, JP-A 2002-069313 or JP-A 2001-115047. The phosphorus compound 9,10-dihydro-9-oxa-10-phosphaphenanthrene-10-oxide (6H-dibenzo[c,e]-oxaphosphorino-6-oxide, DOPO, CAS [35948-25-5]) is particularly, yet not exclusively, preferred.

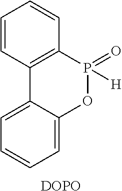

While this flame retardant is already relatively well employable, there is still a need of rendering such polymerizates and polymeric foams even more fire resistant while maintaining a content of flame retardants at a level as low as possible or without increasing the flame retardant content.

It is thus an object of the second aspect of the present invention to create a sufficiently fire resistant, flameproof expandable polymerizate having a low content of flame retardants and good quality.

It is also an object of the second aspect of the invention to create an advantageous method for preparing such polymerizates.

Yet another object of the second aspect of the invention is to create a polymeric foam that is flame protected without the use of halogens but still has sufficient quality and advantageous fire behavior and good mechanical properties, as well as an advantageous method of preparing the same.

In order to achieve this, it is particularly desirable that the polymer is able to meet even the strictest requirements in terms of fire resistance, e.g., for use in construction, such as, for example, the B2 small-flame test according to DIN 4102-2 or the flammability test according to EN 11925-2.

These objects are achieved by the independent claims 17, 26, 29 and 33.

The object according to the second aspect of the invention is achieved for the polymerizate by the characterizing features of claim 17 by further adding sulfur and/or a at least one sulfur-containing compound or sulfur compound as (a) flame retardant(s) or synergist(s).

Surprisingly, it was found that polymerizates and polymeric foams being flame-protected in this way have an flame retardant effect improved by an unexpected level. Thus, the total amount of flame retardants can be reduced, which brings about a plurality of advantages, for example, with respect to the manufacturing method, the costs, mechanical features of the product, etc. In particular, the foaming process and the mechanical features of the foam will not be substantially effected, which results in a product of high quality.

The substituents or residues R in formula (I) are mutually independent and can be the same or different or even absent altogether. For example, at each of the two benzene rings of compound (I), there can be 0 to 4 identical or different residues, which in turn are ether identical to or different from the residues of the other benzene ring.

Herein, the “alkyl” portion of the optional substituents R of the phosphorus compounds of formula (I) means both saturated and unsaturated aliphatics which may be linear or branched, unsaturated groups being preferred. The substituents R preferably comprise short-chain alkyl groups of not more than 6, more preferably not more than 4 or 3, even more preferably not more than 2, carbon atoms or phenyl as an aryl group. Shorter-chain residues are preferred, because longer-chain residues, a high degree of saturation and a higher number of substituents may have a disadvantageous effect on the flame-retarding effect. Particularly effective phosphorus compounds are preferably unsubstituted, e.g. DOPO.

Preferably, if substituents R are present, they bear a sulfur-containing substituent such as —SH, —SO₃NH₄, —SO— or —SO₂— or a phosphorus-containing substituent such as —PO(ONH₄)₂ or the like, in order to further improve the flame-retarding effect.

Among the optional salts of any SH or OH groups of the phosphorus compounds, ammonium and phosphonium salts are preferred as they may also contribute to the flame-retarding effect. The ammonium and phosphonium ions may bear up to four organic residues, e.g. the substituents R as defined above, instead of hydrogen atoms (i.e. NR₄⁺ or PR₄⁺), hydrogen being the preferred substituent in the case of ammonium, though.

A particularly preferred representative of the phosphorus compounds is the compound 9,10-dihydro-9-oxa-10-phosphaphenanththrene-10-oxide (DOPO)

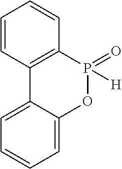

as well as are ring-opened hydrolyzates thereof.

In further preferred phosphorus compounds, the residue R1 is —OH, —ONH₄, —SH, —S-DOPO or —S-DOPS. This gives the following phosphorus compounds: 9,10-dihydro-10-hydroxy-9-oxa-10-phosphaphenanthrene-10-oxide (DOPO-OH), 9,10-dihydro-10-hydroxy-9-oxa-10-phosphaphenanthrene-10-oxide ammonium salt (DOPO-ONH₄), 9,10-dihydro-10-mercapto-9-oxa-10-phosphaphenanthrene-10-oxide (DOPO-SH), bis(9,10-dihydro-9-oxa-10-oxa-10-phosphaphenanthrene-10-yl)oxide (DOPO-S-DOPO), or 9,10-dihydro-10-(9,10-dihydro-10-hydroxy-9-oxa-10-phospha-10-thioxaphenanthrene-10-ylthio)-9-oxa-10-phosphaphenathrene-10-oxide (DOPO-S-DOPS).

An advantageous embodiment of the expandable polymerizates is having the phosphorus compounds contained as (a) flame retardant(s) in an amount of 0.5 to 25% by weight, in particular 3 to 15% by weight, based on the total weight of the polymer.

As sulfur compounds, for example, sulfides, sulfites, sulfates, sulfanes, sulfoxylates, sulfones, thiosulfates, thionites, thionates, disulfates, sulfoxides, sulfuric nitride, sulfuric halides and/or organosulfur compounds such as thiols, thioethers, thiophenes, etc., can be advantageously used.

Particularly suitable are elemental sulfur and yellow cyclooctasulfur (S₈) being preferably added in an amount of 0.1 to 10% by weight, preferably 0.5 to 5% by weight, most preferably about 2% by weight, based on the obtained EPS granulate.

It is advantageous if the sulfur-containing compounds or sulfur compounds exhibit a weight loss of less than 10% by weight, as analyzed by thermogravimetry (TGA) below 115° C., such as ammonium thiosulfate, dicaprolactam disulfide, polyphenylene sulfide, zinc sulfide, etc.

It is particularly advantageous when the sulfur-containing compound or the sulfur compound has at least one S—S bond where at least one of the sulfur atoms is present in the bivalent form, such as disulfites, dithionites, cystines, amylphenol disulfides, poly-tert-butylphenol disulfides, etc.

The inventive expandable polymerizates are preferably expandable styrene polymerizates (EPS) or expandable granular styrene polymer (EPS). Advantageously, they consist of homo- and copolymers of styrene, preferably crystal-clear polystyrene (GPPS), high-impact polystyrene (HIPS), anionically polymerized polystyrene or impact-resistant polystyrene (A-IPS), copolymers of styrene and alpha-methyl-styrene, acrylonitrile-butadiene-styrene polymerizates (ABS), styrene-acrylonitrile (SAN), acrylonitrile-styrene-acrylic ester (ASA), methylacrylate-butadiene-styrene (MBS), methylmethacrylate-acrylonitrile-butadiene-styrene (MABS) polymerizates or mixtures thereof or mixtures with poly(phenylene ether) (PPE). Especially with regard to polystyrene, demand for high-quality products is strong.

For improving mechanical properties or temperature resistance, the styrene polymers mentioned may be mixed, optionally using compatibilizers, with thermoplastic polymers such as polyamides (PA), polyolefins such as polypropylene (PP) or polyethylene (PE), polyacrylates such as poly(methyl methacrylate) (PMMA), polycarbonate (PC), polyesters such as poly(ethylene terephthalate) (PET) or polybutylene terephthalate) (PBT), polyether sulfones (PES), polyether ketones, or polyether sulfides (PES), or mixtures thereof, usually in proportions of a maximum of 30% by weight in total, preferably in the range of 1 to 10% by weight, based on the polymer melt.

Additionally, mixtures in the above amount ranges can also be prepared with e.g. hydrophobically modified or functionalized polymers or oligomers, rubbers such as polyacrylates or polydienes, e.g. styrene-butadiene block copolymers, or biodegradable aliphatic or aliphatic/aromatic copolyesters.

Suitable compatibilizers are, for example, maleic anhydride-modified styrene copolymers, epoxide group-containing polymers or organosilanes.

The efficiency of the flame retardant system can be further improved by adding suitable flame retardant synergists such as thermal radical formers dicumyl peroxide, di-tert-butyl peroxide or dicumyl.

In addition, other flame retardants such as melamine, melamine cyanurate, metal oxides, metal hydroxides, or synergists such as Sb₂O₃ or Zn compounds can be used.

When the polymerizate or polymeric foam is not required to be entirely halogen-free, halogen-reduced foams can be prepared using the phosphorus compounds and adding minor amounts of halogenated, particularly brominated, flame retardants such as hexabromocyclododecane (HBCD), preferably in amounts in the range from 0.05 to 1, in particular 0.1 to 0.5, % by weight.

A further aspect of the invention relates to the preparation of such polymerizates. According to the invention, the flameproof expandable polymerizates mentioned above can be produced as generally known by admixing the above phosphorus compounds and sulfur and/or at least one sulfur-containing compound or sulfur compound.

An advantageous procedure comprises mixing the flame retardant, e.g. DOPO, the sulfur compound(s) and a blowing agent with a styrene polymer melt using a dynamic or static mixer and subsequent granulation.

Alternatively, it may be provided that the flame retardant, e.g. DOPO, and the sulfur compound(s) are mixed into a still granular polystyrene polymerizate using a dynamic or static mixer and then melted, and that the melt is subsequently added with blowing agent and granulated.

Alternatively, it may be provided that the flame retardant, e.g. DOPO, and the sulfur compound(s) are admixed with a still granular EPS using a dynamic or static mixer, and that the mixture is subsequently melted and granulated.

Alternatively, it may further be provided that granulation is achieved by suspension polymerization of styrene in an aqueous suspension in the presence of the flame retardant, e.g. DOPO, and a blowing agent.

A further inventive method for producing the inventive flameproof expandable styrene polymerizates (EPS) comprises the following steps:
jointly dosing granular PS or EPS having a molecular weight of Mw >120,000 g/mol, preferably 150,000 to 250,000 g/mol, more preferably 180,000 to 220,000 g/mol, the flame retardant, especially DOPO, the sulfur compound, and optionally one or more further additives, into an extruder,
jointly melting all components in the extruder,
optionally adding at least one blowing agent,
mixing all components at a temperature >120° C.,
granulation by means of pressurized underwater granulation, e.g. at 1-20 bar, to a granule size <5 mm, preferably 0.2 to 2.5 mm, at a water temperature of 30 to 100° C., most preferably 50 to 80° C.,
optionally coating the surface with coating agents, e.g. silicates, metal salts of fatty acids, fatty acid esters, fatty acid amides.

The inventive halogen-free, flameproof expandable styrene polymers (EPS) and styrene polymer extruded foams (XPS) may be produced by admixing a blowing agent, a phosphorus compound of general formula (I) or a hydrolyzate or salt thereof, and elemental sulfur and/or at least one sulfur-containing compound or sulfur compound, into the polymer melt and subsequent extrusion to give foam sheets, foam strands, or expandable granules.

Preferably, the expandable styrene polymer has a molecular weight >120,000, more preferably in the range of 180,000 to 220,000 g/mol. Due to a decrease in molecular weight because of shearing and/or temperature effects, the molecular weight of the expandable polystyrene is usually about 10,000 g/mol lower than the molecular weight of the polystyrene used.

Further, recycled polymers of the thermoplastic polymers mentioned, especially styrene polymers and expandable styrene polymers (EPS), may be added to the styrene polymer melt, i.e. in amounts that do not substantially deteriorate their properties, usually in amounts of maximum 50% by weight, especially in amounts of 1 to 20% by weight.

The blowing agent-containing styrene polymer melt usually contains one or more homogeneously distributed blowing agent(s) in a proportion of 2 to 10% by weight in total, preferably 3 to 7% by weight, based on the blowing agent-containing styrene polymer melt. Suitable blowing agents are physical blowing agents usually used in EPS such as aliphatic hydrocarbons of 2 to 7 carbon atoms, alcohols, ketones, ethers or halogenated hydrocarbons. Preferably, iso-butane, n-butane, iso-pentane, or n-pentane is used. For XPS, preferably CO₂ or mixtures thereof with alcohols or ketones are used.

The amount of blowing agent added is selected such that the expandable styrene polymers (EPS) have an expansivity of 7 to 200 g/L, preferably 10 to 50 g/L.

The inventive expandable granular styrene polymer (EPS) usually has a bulk density of not more than 700 g/L, preferably in the range of 590 to 660 g/L.

Furthermore, additives, nucleation agents, fillers, plasticizers, soluble and insoluble inorganic and/or organic dyes and pigments, e.g. IR absorbers such as carbon black, graphite or aluminum powder, may be added to the styrene polymer melt, jointly or in a spatially separated way, e.g. via mixers or side extruders. Usually, the dyes and pigments are added in amounts in the range of 0.01 to 30, preferably in the range of 1 to 10, % by weight. For a homogeneous and microdisperse distribution of the pigments in the styrene polymer, it may be useful, especially for polar pigments, to use a dispersing agent, e.g. organosilanes, epoxy group-containing polymers, or maleic anhydride-grafted styrene polymers. Preferred plasticizers are mineral oils, phthalates, which are used in amounts of 0.05 to 10% by weight, based on the styrene polymerizate.

A further aspect of the invention relates to a polymeric foam, in particular a styrene particle foam or an extruded polystyrene rigid foam (XPS), containing at least one of the above phosphorus compounds of general formula (I), or ring-opened hydrolyzates or salts thereof, as well as elemental sulfur and/or at least one sulfur-containing compound or sulfur compound as (a) flame retardant(s).

An advantageous polymeric foam is obtainable from the inventive flameproof expandable polymerizates, especially from expandable styrene polymerizates (EPS), especially by foaming and caking of the polymer beads or by extruding the granulate.

Preferably, the halogen-free, flameproof polymeric foams have a density in the range of 8 to 200 g/L, most preferably in the range of 10 to 50 g/L, and they are preferably more than 80%, most preferably 95 to 100%, closed-cell foams and/or have a predominantly closed-cell structure with more than 0.5 cells per mm³.

According to the invention, at least one of the phosphorus compounds of general formula (I) or ring-opened hydrolyzates or salts thereof, is/are used in combination with sulfur and/or a sulfur-containing compound or sulfur compound as flame retardants or synergists in expandable polymerizates, particularly in expandable styrene polymers (EPS) or expandable styrene polymer granulates (EPS), or in polymeric foams, in particular in styrene polymer particle foams, obtainable by foaming from expandable polymerizates, or in extruded polystyrene rigid foams (XPS).

For preparing flameproof extruded polystyrene rigid foam (XPS), the phosphorus compounds, the sulfur compounds and a blowing agent are mixed with a styrene polymer melt using a dynamic or static mixer and then foamed, or the phosphorus compounds and the sulfur compounds are admixed to a still granular polystyrene polymerizate using a dynamic or static mixer and melted, and the melt is subsequently added with a blowing agent and foamed.

The phosphorus compounds according to (I) that can be used in the invention and methods of preparing the same are known to those skilled in the art. Methods for preparing expandable polymerizates rendered flameproof therewith, e.g. such of EPS, in the form of granulates or beads are also known per se to those skilled in the art. Preparation of polymers according to the invention comprising the above flame retardants and sulfur or a sulfur compound is substantially analogous. For example, the exemplary embodiments of WO 2006/027241 can be used. The same is true for the polymeric foams and for XPS.

How to add the sulfur or the sulfur compounds is also known. For example, elemental sulfur can be introduced in an encapsulated form or as coated granulates or particles.

The present invention according to its second aspect will now be described in detail by way of example, based on four specific exemplary embodiments 1 to 4 which are not to be construed as limiting, though. Examples 5 to 8 are comparative examples in order to show the synergistic effect of DOPO and sulfur.

### EXAMPLE 1

### Exemplary Embodiment—DOPO 7.5%+S

To a styrene polymer (SUNPOR EPS-STD, 6% by weight pentane, chain length Mw=200,000 g/mol, polydispersity Mw/Mn=2.5) 7.5% by weight of 9,10-dihydro-9-oxa-10-phosphaphenanthrene-10-oxide (DOPO) and 2% by weight of yellow sulfur (S₈), based on the obtained EPS granulate, were admixed in the capture area of a twin- screw extruder and melted in the extruder at 190° C. The polymer melt thus obtained was conveyed through a nozzle plate at a throughput of 20 kg/h and granulated to compact EPS granulates using a pressurized underwater granulator.

### EXAMPLE 2

### Exemplary Embodiment—DOPO 15%+S

Example 1 was repeated with the difference that 15% by weight of 9,10-dihydro-9-oxa-10-phosphaphenanthrene-10-oxide (DOPO), based on the obtained EPS granulate, was admixed.

### EXAMPLE 3

### Exemplary Embodiment—DOPO 15%+ATS

Example 2 was repeated with the difference that 6% by weight of ammonium thio-sulfate (ATS), based on the obtained EPS granulate, was admixed.

### EXAMPLE 4

### Exemplary Embodiment—DOPO 15%+DCDS

Example 2 was repeated with the difference that 7% by weight of dicaprolactam disulfide (ATS), based on the obtained EPS granulate, was admixed.

### EXAMPLE 5

### Comparative Example to Example 1—DOPO 7.5% Alone, no S

Example 1 was repeated with the difference that no sulfur was added.

### EXAMPLE 6

### Comparative Example to Example 2—DOPO 15% Alone, no S

Example 2 was repeated with the difference that no sulfur was added.

### EXAMPLE 7

### Comparative Example—S Alone, no DOPO

To a styrene polymer (SUNPOR EPS-STD, 6% by weight pentane, chain length Mw=200,000 g/mol, polydispersity Mw/Mn=2.5) 2% by weight of yellow sulfur (S₈), based on the obtained EPS granulate, were admixed in the capture area of a twin-screw extruder and melted in the extruder at 190° C. The polymer melt thus obtained was conveyed through a nozzle plate at a throughput of 20 kg/h and granulated to compact EPS granulates using a pressurized underwater granulator.

### EXAMPLE 8

### Comparative Example—HBCD Alone, no S, no DOPO

To a styrene polymer (SUNPOR EPS-STD, 6% by weight pentane, chain length Mw=200,000 g/mol, polydispersity Mw/Mn=2.5) 2% by weight of HBCD (hexabromo-cyclododecane), based on the obtained EPS granulate, were admixed in the capture area of a twin-screw extruder and melted in the extruder at 190° C. The polymer melt thus obtained was conveyed through a nozzle plate at a throughput of 20 kg/h and granulated to compact EPS granulates using a pressurized underwater granulator.

In the following Table 1, the results of examinations of the fire behavior of defined specimens, of the time until the foamed foam beads collapsed, and of their odor are juxtaposed in a lucid manner.

TABLE 1
Examination of expandable polymerizates and polymeric foams

| | Fire test | Stability | Odor |
|---|---|---|---|
| Experiment 1 (according to Example 1) | 3 | 3 | 4 |
| Experiment 2 (according to Example 2) | 1 | 4 | 4 |
| Experiment 3 (according to Example 3) | 1 | 2 | 3 |
| Experiment 4 (according to Example 4) | 1 | 3 | 2 |
| Experiment 5 (according to Example 5) | 5 | 2 | 1 |
| Experiment 6 (according to Example 6) | 5 | 4 | 1 |
| Experiment 7 (according to Example 7) | 5 | 1 | 4 |
| Experiment 8 (according to Example 8) | 1 | 1 | 1 |

The experimental results in the two right-side columns were obtained by tests with products of the above described examples 1 through 8.

For example, example 6 corresponding to a polymerizate or foam that is flame-protected only with DOPO and not with sulfur is a direct reference to examples 2, 3, and 4 as the same amounts of DOPO are contained therein.

Another reference to prior art is example 8. All evaluations in all the examinations refer to this reference experiment 8 in that the results are designated by numbers 1 to 5, with low numbers, in particular 1, tending to be more advantageous, and high numbers, in particular 5, being more disadvantageous.

### DETAILED DESCRIPTION

### Fire Test (Column 2 in Table 1):

The EPS granulates obtained from the examples were pre-foamed with saturated steam to give foam beads having a crude density of 15 to 25 kg/m³, stored for 24 hours and molded to foam plates in a molding apparatus.

2 cm specimens were cut from the foam plates and conditioned for 72 hours before being subjected to a fire test according to DIN 4102-2 (B2—small-flame test).

The results scored with numbers from 1 to 5 were evaluated in relation to EPS flame-protected by hexabromocyclododecane (Example 8). In this connection, scores of 1 in the column headed “Fire test” indicate that the test substance acted as well as HBCD-protected EPS regarding its fire behavior. Scores of 5 indicate that the fire behavior is very poor and equals that of EPS that has not been flame-protected.

### Stability of the Foam Structures (Column 3 in Table 1):

The EPS granulates obtained from the examples were exposed to saturated steam, and the time until the beads began to collapse was determined. In the summary of the results, this time was evaluated in relation to EPS particles without flame retardant. Due to the softening effect of flame retardants based on phosphorus, the EPS particles exhibited differing stability during pre-foaming.

In column 3, values of 1 indicate that the beads had normal stability. Values of 5 indicate that the beads collapse immediately without generating a foam structure suitable for moulding.

### Odor (Column 4 in Table 1):

The EPS granulates obtained from the examples were pre-foamed with saturated steam to give foam beads having a crude density of 15 to 25 kg/m³, stored for 24 hours and molded to foam plates in a molding apparatus.

2 cm specimens were cut from the foam plates and conditioned for 72 hours before being subjected to sensory odor testing by several laboratory co-workers. The evaluation was conducted on a subjective basis using the criteria “indiscernible”, which corresponded to score 1, to “offensively disturbing”, which corresponded to score 5.

As clearly seen from these results, the materials of examples 2, 3, and 4 show markedly improved results in fire tests compared to the material of example 6. Although, as seen from example 7, the addition of sulfur alone gives a comparatively poorer fire behavior, experiments 2 through 4 gave surprisingly good results, which were not to be expected at this high level, either. The polymers and foams corresponding to the invention or being protected according to the invention are thus substantially more advantageous than both polymers protected by DOPO alone and polymers treated with sulfur alone.

Even with minor amounts of DOPO, a clear and unexpected increase and improvement of fire resistance was shown (example 1 in comparison to example 5).

Also surprisingly, the stability was not substantially affected or was even increased.

Regarding the odor, while adding the sulfur-containing substances had a detectable effect, it was rather modest, for example, in experiment 4 using dicaprolactam disulfide.

1. Flameproof expandable styrene polymerizates (EPS) or expandable styrene polymer granulates (EPS), preferably being flame-protected without halogen, containing at least one blowing agent, wherein a flame retardant system consisting of a combination of at least one phosphorus compound as a flame retardant and at least one sulfur compound and/or at least one sulfur-containing compound and/or sulfur as an additional flame retardant or synergist is contained, characterized in that
a) said phosphorus compound is
elemental phosphorus, in particular red phosphorus, and/or
at least one inorganic phosphorus compound, or hydrolyzates or salts thereof, and/or
at least one organic phosphorus compound of the following general formula (I) or (II): 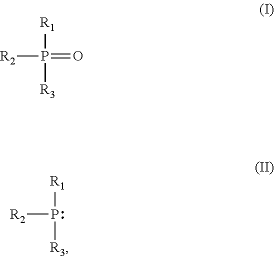
or hydrolyzates or salts thereof, wherein the residues R₁, R₂ and R₃ each independently represent organic or inorganic residues,
and in that
b) said sulfur compound is:
elemental sulfur and/or
at least one inorganic or organic sulfur compound and/or sulfur-containing compound.

2. The expandable polymerizates of claim 1, characterized in that said phosphorus compound(s) is/are contained in an amount of 0.5 to 25% by weight, in particular 3 to 15% by weight, based on the total weight of said polymer.

3. The expandable polymerizates of claim 1, characterized in that said sulfur compound(s) is/are contained in an amount of 0.5 to 25% by weight, in particular 3 to 15% by weight, based on the total weight of said polymer.

4. The expandable polymerizates of claim 1, characterized in that yellow cyclooctasulfur (S₈) is contained in an amount of 0.1 to 10% by weight, in particular in an amount of about 0.5 to 5% by weight, preferably about 2% by weight, based on the total weight of said polymer.

5. The expandable polymerizates of claim 1, characterized in that said sulfur compound(s) exhibit(s) a weight loss of less than 10% by weight, as analyzed by thermogravimetry (TGA) below 115° C.

6. The expandable polymerizates of claim 1, characterized in that said phosphorus compound(s) exhibit(s) a weight loss of less than 10% by weight, as analyzed by thermogravimetry (TGA) below 115° C.

7. The expandable polymerizates of claim 1, characterized in that said sulfur compound(s) has/have at least one S—S bond, where at least one of said sulfur atoms is present in the bivalent form.

8. The expandable polymerizates of claim 1, characterized in that said expandable polymerizates consist of homo- and copolymers of styrene, preferably crystal-clear polystyrene (GPPS), high-impact polystyrene (HIPS), anionically polymerized polystyrene or high-impact polystyrene (A-IPS), styrene-alpha-methylstyrene copolymers, acrylonitrile-butadiene-styrene polymerizates (ABS), styrene-acrylonitrile (SAN), acrylonitrile-styrene-acrylic ester (ASA), methylacrylate-butadiene-styrene (MBS), methylmethacrylate-acrylonitrile-butadiene-styrene (MABS) polymerizates, or mixtures thereof or mixtures with poly(phenylene ether) (PPE) or poly(phenylene sulfide) (PPS).

9. A method of preparing the flameproof expandable polymerizates of claim 1, characterized in that at least one phosphorus compound as defined in claim 1 is used as a flame retardant and at least one sulfur compound as defined in claim 1 is used as an additional flame retardant or synergist.

10. The method of preparing flameproof expandable styrene polymers (EPS) according to claim 9,
wherein said phosphorus compound(s), said sulfur compound(s) and a blowing agent are mixed with a styrene polymer melt using a dynamic or static mixer and then granulated, or
wherein said phosphorus compound(s) and said sulfur compound(s) are admixed to a still granular polystyrene polymer using a dynamic or static mixer and melted, and the melt is subsequently added with a blowing agent and granulated, or
wherein said phosphorus compound(s) and said sulfur compound(s) are admixed to a still granular EPS, and the melt is subsequently melted and granulated, or
wherein granulate preparation is conducted by suspension polymerization of styrene in aqueous suspension in the presence of said phosphorus compound(s), said sulfur compound(s) and a blowing agent.

11. The method of preparing flameproof expandable styrene polymers (EPS) according to claim 9, comprising the steps of:
jointly dosing into an extruder a PS or EPS granulate having a molecular weight of Mw >120,000 g/mol, preferably from 150,000 to 250,000 g/mol, most preferably from 180,000 to 220,000 g/mol, as well as said phosphorus compound(s), said sulfur compound(s), and optionally one or more additional additives, particularly:
a) flame retardant synergists, e.g. thermal radical formers such as dicumyl peroxide in a concentration of 0.1 to 20% by weight,
b) infra-red opacifiers, e.g. graphite, carbon black, aluminium, titanium oxide, in a concentration of 0.1 to 1% by weight,
c) stabilizers, e.g. nitroxyl radical formers such as HTEMPO, in a concentration of 0.1 to 1% by weight,
d) further halogenated or halogen-free flame retardants, e.g. HBCD, DOPO, magnesium hydroxide, in a concentration of 0.1 to 20% by weight, and/or
e) filters, e.g. chalk, talc, silicates, in a concentration of 1 to 20% by weight;
melting all components together inside the extruder;
optionally adding at least one blowing agent;
mixing all components at a temperature of >120° C.;
granulating by pressurized underwater granulation at, for example, 1-20 bar, to give a granulate size of <5 mm, preferably 0.2 to 2.5 mm, at a water temperature of 30 to 100° C., particularly 50 to 80° C.;
optionally coating the surface with coating agents such as silicates, metal salts of fatty acids, fatty acid esters, fatty acid amides.

12. A flameproof expandable styrene polymers (EPS) obtainable by the method of claim 9.

13. A styrene polymeric foam, in particular styrene polymer particle foam or extruded polystyrene rigid foam (XPS), containing at least one phosphorus compound as defined in claim 1 as a flame retardant and at least one sulfur compound as defined in claim 1 as an additional flame retardant or synergist.

14. The styrene polymeric foam of claim 13 obtainable from the flameproof expandable polymerizates of claim 1, in particular by foaming and caking said polymers or by extrusion.

15. The styrene polymeric foam of claim 13 having a density between 7 and 200 g/L and/or a predominantly closed-cell structure with more than 0.5 cells per mm³ or a structure wherein more than 80% of the cells are closed cells.

16. A process using at least one phosphorus compound as defined in claim 1 as a flame retardant in combination with at least one sulfur compound as defined in claim 1 as an additional flame retardant or synergist
in expandable polymerizates, in particular in expandable styrene polymers (EPS) or expandable styrene polymer granulates (EPS) as defined in claim 8, or
in styrene polymeric foams, in particular in styrene polymer particle foams, obtainable by foaming from expandable polymerizates, or in extruded polystyrene rigid foams (XPS).

17. A flameproof expandable polymerizates containing at least one blowing agent, wherein at least one phosphorus compound of the following general formula (I) or hydrolyzates or salts thereof is/are contained as (a) flame retardant(s): 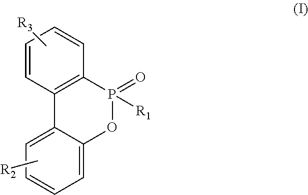
wherein each residue R represents independently:
—H, substituted or unsubstituted C₁₋₁₅ alkyl, C₁₋₁₅ alkenyl, C₃₋₈ cycloalkyl, C₆₋₁₈ aryl, C₇₋₃₀ alkylaryl, C₁₋₈ alkoxy or C₁₋₈ alkylthio or —OH or —SH, as well as alkali metal, alkaline earth metal, ammonium or phosphonium salts thereof, characterized in that sulfur and/or at least one sulfur-containing compound and/or sulfur compound is contained as (an) additional flame retardant(s) or synergist(s).

18. The expandable polymerizates of claim 17, characterized in that each residue R represents alkyl, alkoxy or alkylthio groups of 1 to 4 carbon atoms, more preferably 1 or 2 carbon atoms.

19. The expandable polymerizates of claim 17, characterized in that each residue R bears a sulfur- and/or phosphorus-containing substituent.

20. The expandable polymerizates of claim 17, characterized in that 9,10-dihydro-9-oxa-10-phosphaphenanthrene-10-oxid (DOPO) 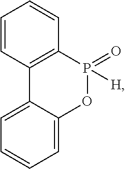
hydrolyzate or a metal salt thereof is contained as the phosphorus compound.

21. The expandable polymerizates of claim 17, characterized in that the phosphorus compound(s) is/are contained as a flame retardant in an amount of 0.5 to 25% by weight, in particular 3 to 15% by weight, based on the total weight of said polymer.

22. The expandable polymerizates of claim 17, characterized in that yellow cyclooctasulfur (S₈) is contained in an amount of 0.1 to 10% by weight, in particular in an amount of about 0.5 to 5% by weight, preferably about 2% by weight, based on the total weight of said polymer.

23. The expandable polymerizates of claim 17, characterized in that said sulfur-containing compounds or sulfur compounds exhibit a weight loss of less than 10% by weight, as analyzed by thermogravimetry (TGA) below 115° C.

24. The expandable polymerizates of claim 17, characterized in that said sulfur-containing compound or sulfur compound has at least one S—S bond, wherein at least one of said sulfur atoms is present in the bivalent form.

25. The expandable polymerizates of claim 17, characterized in that said expandable polymerizates are expandable styrene polymers (EPS) or expandable styrene polymer granulates (EPS), which particularly consist of homo- and copolymers of styrene, preferably crystal-clear polystyrene (GPPS), high-impact polystyrene (HIPS), anionically polymerized polystyrene or high-impact polystyrene (A-IPS), styrene-alpha-methylstyrene copolymers, acrylonitrile-butadiene-styrene polymerizates (ABS), styrene-acrylonitrile (SAN), acrylonitrile-styrene-acrylic ester (ASA), methylacrylate-butadiene-styrene (MBS), methylmethacrylate-acrylonitrile-butadiene-styrene (MABS) polymerizates, or mixtures thereof or mixtures with poly(phenylene ether) (PPE).

26. A method of preparing the flameproof expandable polymerizates according to claim 17, characterized in that at least one phosphorus compound of the general formula (I) as defined in claim 1 or ring-opened hydrolyzates or salts thereof is/are used as (a) flame retardant(s) and sulfur and/or at least one sulfur-containing compound or sulfur compound as defined in claim 1 is/are used as (an) additional flame retardant(s) or synergist(s).

27. The method of preparing flameproof expandable polymerizates (EPS) according to claim 26,
wherein said phosphorus compound, said sulfur or sulfur compound and a blowing agent are mixed with a styrene polymer melt using a dynamic or static mixer and then granulated, or
wherein said phosphorus compound and said sulfur or sulfur compound are admixed to a still granular polystyrene polymer using a dynamic or static mixer and melted, and the melt is subsequently added with a blowing agent and granulated, or
wherein said phosphorus compound and said sulfur or sulfur compound are admixed to a still granular EPS, and the melt is subsequently melted and granulated, or
wherein granulate preparation is conducted by suspension polymerization of styrene in aqueous suspension in the presence of said phosphorus compound(s), said sulfur compound(s) and a blowing agent.

28. The method of preparing flameproof expandable styrene polymers (EPS) according to claim 26, comprising the steps of:
jointly dosing into an extruder PS or EPS granulate having a molecular weight of Mw >120,000 g/mol, preferably from 150,000 to 250,000 g/mol, most preferably from 180,000 to 220,000 g/mol, as well as said phosphorus compound(s), said sulfur compound(s), and optionally one or more additional additives, particularly:
a) flame retardant synergists, e.g. thermal radical formers such as dicumyl peroxide, in a concentration of 0.1 to 20% by weight,
b) infra-red opacifiers, e.g. graphite, carbon black, aluminium, titanium oxide, in a concentration of 0.1 to 1% by weight,
c) stabilizers, e.g. nitroxyl radical formers such as HTEMPO, in a concentration of 0.1 to 1% by weight,
d) other halogenated or halogen-free flame retardants, e.g. HBCD, DOPO, magnesium hydroxide, in a concentration of 0.1 to 20% by weight, and/or
e) filters, e.g. chalk, talc, silicates, in a concentration of 1 to 20% by weight;
melting all components together inside the extruder;
optionally admixing at least one blowing agent;
mixing all components at a temperature of >120° C.;
granulating by pressurized underwater granulation at, for example, 1-20 bar, to an granulate size of <5 mm, preferably 0.2 to 2.5 mm, at a water temperature of 30 to 100° C., in particular of 50 to 80° C.;
optionally coating the surface with coating agents such as silicates, metal salts of fatty acids, fatty acid esters, fatty acid amides.

29. A flameproof expandable styrene polymerizates (EPS) obtainable by the method of claim 26.

30. A polymeric foam, in particular styrene polymer particle foam or extruded polystyrene rigid foam (XPS), containing at least one phosphorus compound of the general formula (I) as defined in claim 17, and/or hydrolyzates or salts thereof, as (a) flame retardant(s) and sulfur and/or at least one sulfur-containing compound or sulfur compound as defined in claim 17 as (an) additional flame retardant(s) or synergist(s).

31. The polymeric foam of claim 30 obtainable from the flameproof expandable polymerizates of claim 17, in particular from expandable styrene polymers (EPS), in particular by foaming and caking said polymersizates or by extrusion.

32. The polymeric foam of claim 30 having a density of between 7 and 200 g/L and/or a predominantly closed-cell structure with more than 0.5 cells per mm³ or a structure wherein more than 80% of the cells are closed cells.

33. A process of using at least one phosphorus compound of general formula (I) as defined in claim 17, and/or of hydrolyzates or salts thereof, in combination with sulfur and/or at least one sulfur-containing compound or sulfur compound as defined in claim 1 as flame retardants and synergists, respectively,
in expandable polymerizates, in particular in expandable styrene polymers (EPS) and/or expandable styrene polymer granulates (EPS) as defined in claim 25, or
in polymeric foams, in particular in styrene polymer particle foams, obtainable by foaming from expandable polymerizates, or in extruded polystyrene rigid foams (XPS).
